(19) United States
(12) Patent Application Publication
(10) Pub. No.: US 2025/0284226 A1
(43) Pub. Date: Sep. 11, 2025

(54) DEVELOPING DEVICE, PROCESS CARTRIDGE, AND IMAGE FORMING APPARATUS

(71) Applicant: Yuta YABUTA, Kanagawa (JP)

(72) Inventor: Yuta YABUTA, Kanagawa (JP)

(73) Assignee: Ricoh Company, Ltd., Tokyo (JP)

(21) Appl. No.: 19/061,336

(22) Filed: Feb. 24, 2025

(30) Foreign Application Priority Data
Mar. 8, 2024 (JP) 2024-036002

(51) Int. Cl. G03G 15/08; G03G 15/00; G03G 21/18

(52) U.S. Cl. CPC G03G 15/0893; G03G 15/0808; G03G 15/0849; G03G 15/556; G03G 21/1814

(57) ABSTRACT

A developing device that develops a latent image formed on a surface of an image bearer includes a housing, a developing roller, a first conveying screw, a second conveying screw, a partition, and a toner concentration sensor. The first conveying screw is disposed below the developing roller and supplies developer to the developing roller. The second conveying screw is disposed below the first conveying screw and forms a circulation path for the developer together with the first conveying screw. The partition separates a first conveyance path and a second conveyance path in a region excluding a first communication portion formed on one end of the housing and a second communication portion formed on the other end of the housing. A detection region of the toner concentration sensor is located below the partition at a bottom of the second conveyance path and at a position close to the first communication portion.

### CROSS-REFERENCE TO RELATED APPLICATION

This patent application is based on and claims priority pursuant to 35 U.S.C. § 119 (a) to Japanese Patent Application No. 2024-036002, filed on Mar. 8, 2024, in the Japan Patent Office, the entire disclosure of which is hereby incorporated by reference herein.

### BACKGROUND

### Technical Field

Embodiments of the present disclosure relate to a developing device that develops a latent image formed on a surface of an image bearer, a process cartridge including the developing device, and an image forming apparatus including the developing device.

### Related Art

An electrophotographic image forming apparatus such as a copying machine, a printer, a facsimile machine, or a multifunction peripheral thereof includes a developing device that conveys developer. For example, a developing device has been proposed that includes a circulation path for circulating the developer with two conveying screws disposed in an up-and-down direction. A first conveying screw is disposed to face a lower portion of a developing roller. A second conveying screw is disposed opposite a lower portion of the first conveying screw. On the other hand, a technique has also been proposed in which a toner concentration sensor for detecting the toner concentration of the developer circulating in the developing device is disposed at a bottom portion of a second conveyance passage in which the second conveying screw is disposed.

### SUMMARY

In an embodiment of the present disclosure, a developing device that develops a latent image formed on a surface of an image bearer includes a housing, a developing roller, a first conveying screw, a second conveying screw, a partition, and a toner concentration sensor. The housing stores developer. The developing roller faces the image bearer and bears the developer. The first conveying screw is disposed below the developing roller, faces the developing roller, supplies the developer to the developing roller while conveying the developer from one end to another end of the housing in a longitudinal direction of the housing, and collects the developer separated from the developing roller. The second conveying screw is disposed below and opposite the first conveying screw, conveys the developer from the other end to the one end of the housing in the longitudinal direction, and forms a circulation path for the developer together with the first conveying screw. The partition separates a first conveyance path in which the first conveying screw is disposed and a second conveyance path in which the second conveying screw is disposed, in a region excluding a first communication portion formed on the one end of the housing in the longitudinal direction and a second communication portion formed on the other end of the housing in the longitudinal direction. The toner concentration sensor detects a toner concentration of the developer. A detection region of the toner concentration sensor in the longitudinal direction is located below the partition at a bottom of the second conveyance path and at a position close to the first communication portion.

In another embodiment of the present disclosure, a process cartridge attachable to and detachable from a body of an image forming apparatus includes the developing device and the image bearer united with the developing device.

In another embodiment of the present disclosure, an image forming apparatus includes the developing device and the image bearer.

In another embodiment of the present disclosure, a developing device that develops a latent image formed on a surface of an image bearer includes a housing, a developing roller, a first conveying screw, a second conveying screw, and a toner concentration sensor. The housing stores developer. The developing roller faces the image bearer and bears the developer. The first conveying screw is disposed below the developing roller, faces the developing roller, supplies the developer to the developing roller while conveying the developer from one end to another end of the housing in a longitudinal direction of the housing, and collects the developer separated from the developing roller. The second conveying screw is disposed below and opposite the first conveying screw, conveys the developer from the other end to the one end of the housing in the longitudinal direction, and forms a circulation path for the developer together with the first conveying screw. The toner concentration sensor detects a toner concentration of the developer. A roller diameter of the developing roller is greater than a screw diameter of the second conveying screw. The screw diameter of the second conveying screw is greater than a screw diameter of the first conveying screw.

In another embodiment of the present disclosure, a process cartridge attachable to and detachable from a body of an image forming apparatus includes the developing device and the image bearer united with the developing device.

In another embodiment of the present disclosure, an image forming apparatus includes the developing device and the image bearer.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus according to an embodiment of the present disclosure;

FIG. 2 is a diagram illustrating an image forming device of the image forming apparatus of FIG. 1;

FIG. 3 is a sectional view of a developing device as viewed in a longitudinal direction;

FIG. 4 is a diagram illustrating a state of developer stored in the developing device of FIG. 3;

FIG. 5 is an enlarged view of one end of the developing device of FIG. 3 in the longitudinal direction;

FIGS. 6A and 6B are diagrams each illustrating a relation between a rotation direction of a first conveying screw and the delivery of developer to a developing roller by the first conveying screw; and

FIG. 7 is a diagram illustrating a positional relation of a developing roller, a first conveying screw, a second conveying screw, and a toner concentration sensor.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. Embodiments of the present disclosure are described below in detail with reference to the drawings. Like reference signs are assigned to like elements or components and descriptions of those elements or components may be simplified or omitted. As used herein, the singular forms “a,” “an,” and “the” are intended to include the plural forms as well, unless the context clearly indicates otherwise.

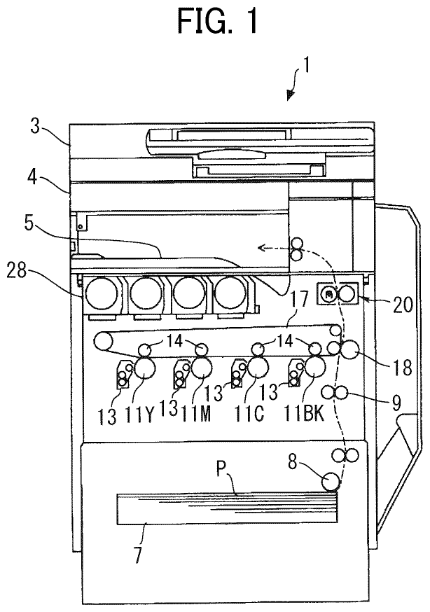

A description is given of an overall configuration and operation of an image forming apparatus 1 below with reference to FIG. 1. In FIG. 1, the image forming apparatus 1, which is illustrated as a tandem-type color copier in the present embodiment, includes a document conveying device 3, a scanner 4 (document reading device), and an ejection tray 5. The document conveying device 3 conveys documents to the scanner 4. The scanner 4 scans the documents to read image data. The ejection tray 5 stacks sheets P on which output images are formed. The image forming apparatus 1 further includes a sheet feeder 7, a registration roller pair 9, and four drum-shaped photoconductor drums 11Y, 11M, 11C, and 11BK. The sheet feeder 7 stores sheets P such as paper sheets. The registration roller pair 9 adjusts a conveyance timing of a sheet P. The photoconductor drums 11Y, 11M, 11C, and 11BK as an image bearer bear toner images of yellow, magenta, cyan, and black, respectively. The image forming apparatus 1 further includes a developing device 13, primary-transfer bias rollers 14, and an intermediate transfer belt 17. The developing device 13 develops electrostatic latent images formed on the surfaces of the photoconductor drums 11Y, 11M, 11C, and 11BK. The primary-transfer bias rollers 14 transfer toner images formed on the surfaces of the photoconductor drums 11Y, 11M, 11C, and 11BK onto the intermediate transfer belt 17. The image forming apparatus 1 further includes a secondary-transfer bias roller 18, a fixing device 20, and toner containers 28. The secondary-transfer bias roller 18 transfers the toner images from the intermediate transfer belt 17 onto the sheet P as a color toner image. The fixing device 20 fixes the unfixed color toner image onto the sheet P. The toner containers 28 supply toners of respective colors (yellow, magenta, cyan, and black) to the developing devices 13.

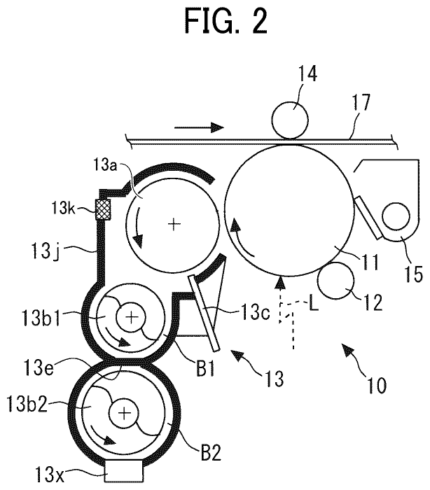

A description is given below of operations of the image forming apparatus 1 to form a normal color toner image. The image forming process performed on the surfaces of the photoconductor drums 11Y, 11M, 11C, and 11BK are also described with reference to FIG. 2. Conveying rollers of the document conveying device 3 convey a document on a document table onto an exposure glass of the scanner 4. The scanner 4 optically scans the document on the exposure glass to read image data. The yellow, magenta, cyan, and black image data are transmitted to a writing device. The writing device emits laser beams L (e.g., exposure light) onto the surfaces of the photoconductor drums 11Y, 11M, 11C, and 11BK according to the image data of yellow, magenta, cyan, and black, respectively.

Each of the four photoconductor drums 11Y, 11M, 11C, and 11BK rotates clockwise in FIG. 1. Chargers 12 (see FIG. 2) disposed opposite the photoconductor drums 11Y, 11M, 11C, and 11BK uniformly charge the outer circumferential surfaces of the photoconductor drums 11Y, 11M, 11C, and 11BK, respectively (a charging process). Thus, a charging potential is formed on the surface of each of the photoconductor drums 11Y, 11M, 11C, and 11BK. Subsequently, the surface of each of the photoconductor drums 11Y, 11M, 11C, and 11BK thus charged reaches a position where the surface of each of the photoconductor drum 11Y, 11M, 11C, and 11BK is irradiated with the laser beam L. In an exposure process, four light sources of the writing device emit the laser beam L according to the image signals for the respective colors of yellow, cyan, magenta, and black. The respective laser beams L pass through different optical paths for components of yellow, magenta, cyan, and black (an exposure process).

The laser beam L corresponding to the yellow component is emitted to the surface of the leftmost photoconductor drum 11Y in FIG. 1. A polygon mirror that rotates at high velocity deflects the laser beam L for yellow along the axis of rotation of the photoconductor drum 11Y (i.e., a main scanning direction) so that the laser beam scans the surface of the photoconductor drum 11Y. Thus, an electrostatic latent image corresponding to the image data of yellow is formed on the photoconductor drum 11Y charged by the charger 12.

Similarly, the laser beam L corresponding to the magenta component is emitted to the surface of the second photoconductor drum 11M from the left in FIG. 1. Thus, an electrostatic latent image corresponding to the magenta component is formed. The laser beam L corresponding to the cyan component is emitted to the surface of the third photoconductor drum 11C from the left in FIG. 1. Thus, an electrostatic latent image corresponding to the cyan component is formed. The laser beam L corresponding to the black component is emitted to the surface of the fourth photoconductor drum 11BK from the left in FIG. 1. Thus, an electrostatic latent image corresponding to the black component is formed.

Thereafter, the surface of each of the photoconductor drums 11Y, 11M, 11C, and 11BK bearing the electrostatic latent image reaches a developing position opposite the developing device 13. The developing device 13 supplies toner of each color onto the surface of each of the photoconductor drums 11Y, 11M, 11C, and 11BK and develops the electrostatic latent image on each of the photoconductor drums 11Y, 11M, 11C, and 11BK into a toner image (a development process). After the development process, the surfaces of the photoconductor drums 11Y, 11M, 11C, and 11BK reach positions facing the intermediate transfer belt 17. The primary-transfer bias rollers 14 are disposed at positions where the photoconductor drums 11Y, 11M, 11C, and 11BK face the intermediate transfer belt 17 to contact an inner circumferential surface of the intermediate transfer belt 17. At the positions of the primary-transfer bias rollers 14, the toner images on the photoconductor drums 11Y, 11M, 11C, and 11BK are sequentially transferred and superimposed onto the intermediate transfer belt 17, forming a multicolor toner image thereon (a primary transfer process). After the primary transfer process, the surfaces of the respective photoconductor drums 11Y, 11M, 11C, and 11BK reach cleaning positions opposite the respective cleaning devices 15. The cleaning devices 15 remove and collect the residual (untransferred) toner from the outer circumferential surfaces of the photoconductor drums 11Y, 11M, 11C, and 11BK (a cleaning process). Thereafter, the outer circumferential surfaces of the photoconductor drums 11Y, 11M, 11C, and 11BK pass through dischargers to complete a series of image forming processes performed on the photoconductor drums 11Y, 11M, 11C, and 11BK.

On the other hand, the multicolor toner image is formed on the intermediate transfer belt 17 by transferring (bearing) and superimposing the respective single-color toner images on the photoconductor drums 11Y, 11M, 11C, and 11BK. Then, the intermediate transfer belt 17 bearing the multicolor toner image moves counterclockwise in FIG. 1 to reach a position opposite the secondary-transfer bias roller 18. The multicolor toner image borne on the intermediate transfer belt 17 is transferred onto the sheet P at the position facing the secondary-transfer bias roller 18 (a secondary transfer process). Thereafter, the outer circumferential surface of the intermediate transfer belt 17 reaches a cleaning position opposite an intermediate-transfer-belt cleaner. The intermediate-transfer-belt cleaner collects untransferred toner adhering to the intermediate transfer belt 17 to complete a series of transfer processes performed on the intermediate transfer belt 17.

The sheet Pis conveyed from the sheet feeder 7 via the registration roller pair 9 to a secondary transfer nip between the intermediate transfer belt 17 and the secondary-transfer bias roller 18. In detail, a feed roller 8 feeds the sheet P from the sheet feeder 7 that stores multiple sheets P, and the sheet P is conveyed to the registration roller pair 9 through a conveyance guide. The registration roller pair 9 starts rotating at a timing at which the sheet P can receive a toner image from the surface of the intermediate transfer belt 17 in the secondary transfer nip region, to feed the sheet P toward the secondary transfer nip region. Subsequently, the sheet P, onto which the multicolor image is transferred, is conveyed to a fixing device 20. The fixing device 20 includes a fixing roller and a pressure roller pressing against each other. In a nip between the fixing roller and the pressure roller, the multicolor toner image is fixed on the sheet P. After the fixing process, an output roller pair ejects the sheet P as an output image outside a body of the image forming apparatus 1. The ejected sheets P are stacked on an output tray 5. Thus, a series of image forming processes is completed.

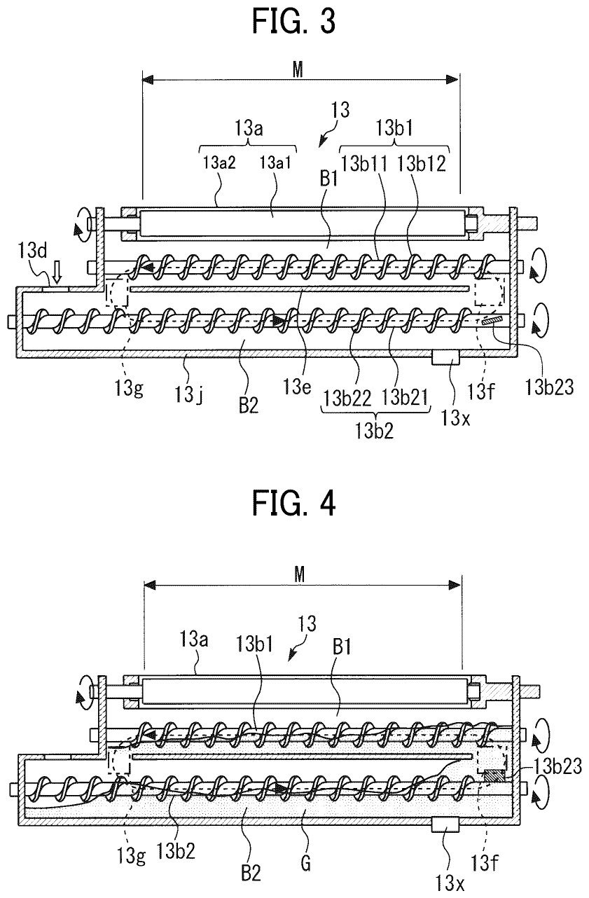

A description is given of a process cartridge 10 (image forming device) in the image forming apparatus 1 in detail with reference to FIGS. 2 and 3. FIG. 2 is a sectional view of the process cartridge 10 (image forming device) viewed in a cross-section orthogonal to the rotation axis of the photoconductor drum 11. FIG. 3 is a sectional view of the developing device 13 viewed in a longitudinal direction (a sectional view in a vertical direction). Once the image forming devices have substantially the same structure, the process cartridge 10 and the developing device 13 are illustrated in FIGS. 2 and 3 with the alphabets (Y, C, M, and BK) omitted from the reference signs.

As illustrated in FIG. 2, the process cartridge is a unit in which the photoconductor drum 11 as an image bearer, the charger 12 (and a cleaning roller 22), the developing device 13, and the cleaning device 15 are united, and is removably installed in the body of the image forming apparatus 1. When the process cartridge 10 reaches the end of its product life, the process cartridge 10 is removed from the body of the image forming apparatus 1 and is replaced with a new one.

The photoconductor drum 11 as the image bearer is a negatively-charged organic photoconductor and is driven to rotate clockwise in FIG. 2 by a rotational drive mechanism. The charger 12 is an elastic charging roller and includes a core and an elastic layer of moderate resistivity covering the core. For example, the elastic layer is a foamed urethane layer (which is formed on the core in a roller shape) that includes urethane resin, carbon black, as conductive particles, a sulfuration agent, and a foaming agent. The material of the elastic layer of moderate resistivity in the charger 12 is, for example, a rubber material in which a conductive substance such as carbon black or a metal oxide for resistance adjustment is dispersed in urethane, ethylene-propylene-diene polyethylene (EPDM), butadiene acrylonitrile rubber (NBR), silicone rubber, or isoprene rubber, or a foamed material thereof. The cleaning device 15 includes a cleaning blade that slidingly contacts the photoconductor drum 11 and mechanically removes and collects the untransferred toner from the photoconductor drum 11.

The developing device 13 is disposed such that a developing roller 13a as a developer bearer faces the photoconductor drum 11 with a slight gap therebetween, and a developing region where the photoconductor drum 11 and a magnetic brush (that is developer G in a standing state) contact each other is formed in a portion where the developing roller 13a and the photoconductor drum 11 face each other. The developing device 13 stores developer G (two-component developer) including toner and carrier. The developing device 13 develops the electrostatic latent image on the surface of the photoconductor drum 11 to form a toner image.

With reference to FIG. 1, a toner container 28 stores toner T to be supplied into the developing device 13. Specifically, the toner Tis appropriately supplied from the toner container 28 through a supply port 13d (see FIG. 3) of the developing device 13 through a toner conveyance pipe based on data of the toner concentration (that is the ratio of toner in developer G) detected by a toner concentration sensor 13x such as a magnetic sensor disposed in the developing device 13.

A description is given below of the developing device 13 in the image forming apparatus is described in detail. With reference to FIGS. 2 and 3, the developing device 13 includes the developing roller 13a as the developer bearer, a first conveying screw 13b1 as a first conveyor, a second conveying screw 13b2 as a second conveyor, a doctor blade 13c as a developer regulator, a partition 13e as a wall, a developing case 13j that covers the developing device 13, and a filter 13k that covers a vent. The developing roller 13a, the first conveying screw 13b1, the second conveying screw 13b2, the doctor blade 13c, and the partition 13e are housed in the developing case 13j (a housing). The developing roller 13a as the developer bearer includes a sleeve 13a2 that is a cylinder made of nonmagnetic material such as aluminum, brass, stainless steel, or conductive resins. The rotational drive mechanism rotates the sleeve 13a2 in the direction indicated by an arrow illustrated in FIG. 2 together with the first conveying screw 13b1 and the second conveying screw 13b2. A magnet 13al forms a plurality of magnetic poles on the circumferential surface of the sleeve 13a2 and is fixed in the sleeve 13a2 of the developing roller 13a. The developing roller 13a rotates in a specified direction (that is counterclockwise direction in FIG. 2) to convey the developer G borne on the developing roller 13a. Thus, the developer G reaches the position of the doctor blade 13c as the developer regulator. The doctor blade 13c adjusts the amount of the developer G on the developing roller 13a to a proper amount at the position. Subsequently, the developer G is conveyed to the position (the developing region) where the developing roller 13a faces the photoconductor drum 11. Then, the toner in the developer G is attracted to the electrostatic latent image formed on the photoconductor drum 11 due to the effect of an electric field (development electric field) generated in the developing region.

The plurality of magnetic poles that are formed around the developing roller 13a (or the sleeve 13a2) by the magnet 13al include an N1 pole (a main magnetic pole), an S2 pole (a conveying magnetic pole), an N2 pole (a pre-developer-release magnetic pole), an N pole (a developer-release magnetic pole), an N3 pole (a post-developer-release magnetic pole), and an S1 pole (a scooping magnetic pole). The N1 pole is formed at a position facing the photoconductor drum 11. The S2 pole is formed at a position downstream from the N1 pole (in the rotation direction of the developing roller 13a) and at a position facing an upper portion of the developing case 13j. The N2 pole is formed at a position downstream from the S2 pole in the rotation direction and at a position obliquely above the developing roller 13a. The N pole is formed at a position between the N2 pole and the N3 pole and at a position above a first conveyance path B1. The N3 pole is formed at a position downstream from the N pole in the rotation direction and a position above the first conveyance path B1. The S1 pole is formed from a position facing the first conveying screw 13b1 to a position close to a position facing the doctor blade 13c. First, the S1 pole (scooping magnetic pole) acts on the carrier as magnetic materials, and developer G contained in the first conveyance passage B1 is scooped up onto the developing roller 13a. A part of the developer G borne on the developing roller 13a is scraped off at the position of the doctor blade 13c and returned to the first conveyance passage B1. On the other hand, after the developer G passes through a doctor gap between the doctor blade 13c and the developing roller 13a at the position of the doctor blade 13c where the magnetic force by the scooping magnetic pole S1 acts, the developer G borne on the developing roller 13a stands at the position of the N1 pole (main magnetic pole), forms a magnetic brush in the developing region, and slidingly contacts the photoconductor drum 11. Thus, the toner in the developer G borne on the developing roller 13a adheres to the latent image formed on the photoconductor drum 11. After the developer G passes through the position of the N1 pole, the S2 pole and the N2 pole convey the developer G to the position of the developer-release magnetic pole (N pole). At the position of the developer-release magnetic pole, a repulsive magnetic field acts on the carrier (the magnetic field that acts in a direction away from the developing roller 13a). As a result, the developer G borne on the developing roller 13a after the developing process is separated from the developing roller 13a. The developer G separated from the developing roller 13a falls into the first conveyance passage B1, and the first conveying screw 13b1 collects the developer G and conveys the developer G toward a downstream portion of the first conveyance passage B1.

With reference to FIG. 2, the doctor blade 13c as a developer regulator is a magnetic plate-shaped member and disposed below the developing roller 13a to face the developing roller 13a. The developing roller 13a rotates counterclockwise in FIG. 2, and the photoconductor drum 11 rotates clockwise in FIG. 2. With such a configuration, even when the photoconductor drum 11 is disposed below the intermediate transfer belt 17 for the purpose of shortening the conveyance path of the sheet P and downsizing the body of the image forming apparatus 1 in a horizontal direction, the developing roller 13a can rotate in the forward direction with respect to the photoconductor drum 11 in the developing gap. A sufficient development time can be obtained in the developing gap as compared to a case where the doctor blade 13c is disposed above the developing roller 13a and the developing roller 13a rotates in the reverse direction with respect to the photoconductor drum 11. Thus, the developing performance can be enhanced.

The two conveying screws (the first conveying screw 13b1 and the second conveying screw 13b2) stir and mix the developer G contained in the developing device 13 while circulating the developer G in a longitudinal direction (the direction perpendicular to the plane on which FIG. 2 is illustrated and a left-and-right direction in FIG. 3). The first conveying screw 13b1 and the second conveying screw 13b2 are screws in which a screw portion 13b12 and a screw portion 13b22 are spirally wound around a shaft 13b11 and a shaft 13b21, respectively.

The first conveying screw 13b1 is disposed below the developing roller 13a to face the developing roller 13a, supplies the developer to the developing roller 13a while conveying the developer G from one end in the longitudinal direction toward the other end in the longitudinal direction, and collects the developer separated from the developing roller 13a. The first conveying screw 13b1 is disposed below the developing roller 13a and at a position where the first conveying screw 13b1 faces the developing roller 13a. The first conveying screw 13b1 horizontally conveys the developer G in the longitudinal direction (rotation axis direction), which is the conveyance from right to left as indicated by the dashed arrow in FIG. 3, supplies onto the developing roller 13a at the position of the scooping magnetic pole (S1 pole), and conveys the developer G separated and dropped from the developing roller 13a at the position of the developer-release magnetic pole (N pole) toward the downstream side in the axial direction. The first conveying screw 13b1 rotates counterclockwise in FIG. 2.

The second conveying screw 13b2 is disposed below the first conveying screw 13b1 (first conveyor) to face the first conveying screw 13b1 and conveys the developer G from the other end in the longitudinal direction toward one end in the longitudinal direction to form a circulation path of the developer G together with the first conveying screw 13b1. Specifically, the second conveying screw 13b2 is disposed below the first conveying screw 13b1 and at a position facing the developing roller 13a via the first conveying screw 13b1. The second conveying screw 13b2 horizontally conveys the developer G in a second conveyance path B2 in the longitudinal direction, which is the conveyance from left to right as indicated by the dashed arrow in FIG. 3. In the present embodiment, the rotational direction of the second conveying screw 13b2 is set to be the same direction (counterclockwise direction in FIG. 2) as the rotational direction of the first conveying screw 13b1.

Each of the developing roller 13a (sleeve 13a2), the first conveying screw 13b1, and the second conveying screw 13b2 has a shaft and a gear fixed at one end of the shaft (the right end of the shaft in FIG. 3). These gears form a gear train and rotate the developing roller 13a (sleeve 13a2), the first conveying screw 13b1, and the second conveying screw 13b2 in the above-described rotation direction. The first conveying screw 13b1 and the second conveying screw 13b2 are rotatably held by the developing case 13j via bearings at the shaft 13b11 and the shaft 13b21 at both ends of the first conveying screw 13b1 and the second conveying screw 13b2.

The second conveying screw 13b2 circulates the developer G from the downstream side in the axial direction of the first conveyance path B1 including the first conveying screw 13b1 via a second communication portion 13g (second relay portion). The second conveying screw 13b2 conveys the developer G to the upstream side in the axial direction of the first conveyance path B1 including the first conveying screw 13b1 via a first communication portion 13f (first relay portion) (conveyance indicated by a broken line arrow in FIG. 3). The first conveying screw 13b1 and the second conveying screw 13b2 are disposed in a manner such that the rotation shafts of the first conveying screw 13b1 and the second conveying screw 13b2 are substantially horizontal similarly to the developing roller 13a and the photoconductor drum 11. The first conveying screw 13b1 and the second conveying screw 13b2 have the screw portion 13b12 and the screw portion 13b22 spirally wound around the shaft 13b11 and the shaft 13b21, respectively. Each of the screw portion 13b12 and the screw portion 13b22 has a specified screw pitch and the number of threads is one. Each of the screw portion 13b12 and the screw portion 13b22 may have a plurality of threads in order to stabilize the conveyance of the developer. In particular, the screw portion 13b12 of the first conveying screw 13b1 may have a plurality of threads.

The first conveyance path B1 including the first conveying screw 13b1 and the second conveyance path B2 including the second conveying screw 13b2 are separated from each other by the partition 13e (wall). With reference to FIG. 3, the upstream side of the first conveyance path B1 including the first conveying screw 13b1 and the downstream side of the second conveyance path B2 including the second conveying screw 13b2 communicate with each other via the first communication portion 13f. The developer G that has reached the downstream side of the second conveyance path B2 including the second conveying screw 13b2 stays and rises up in the vicinity of the first communication portion 13f, and is conveyed (supplied) to the upstream side of the first conveyance path B1 by the first conveying screw 13b1 via the first communication portion 13f (see also FIG. 4). With reference to FIG. 3, the downstream side of the first conveyance path B1 including the first conveying screw 13b1 and the upstream side of the second conveyance path B2 including the second conveying screw 13b2 communicate with each other via the second communication portion 13g. The developer G that has reached the downstream side of the first conveyance path B1 by the first conveying screw 13b1 (the developer G that has not been supplied onto the developing roller 13a in the first conveyance path B1, or the developer G that has separated and dropped from the developing roller 13a at the position of the fourth magnetic pole) drops by its own weight in the second communication portion 13g, and reaches the upstream side of the second conveyance path B2.

With reference to FIGS. 3, 4, and 5, the second conveying screw 13b2 in the present embodiment has a paddle portion 13b23 that stands in the radial direction on the shaft 13b21 that faces the first communication portion 13f in order to enhance the conveyance performance of the developer G in the first communication portion B2 (i.e., the delivery of the developer G from the second conveyance path B2 to the first conveyance path B1 against the gravity direction). In particular, in the present embodiment, the paddle portion 13b23 is formed to stand not in parallel to the rotation shaft but obliquely to the rotation shaft. Such a configuration can smoothly deliver the developer G to the first communication portion 13f while weakening the force of the developer G conveyed downstream in the second conveyance path B2.

With such a configuration, the two conveyors (i.e., the first conveying screw 13b1 and the second conveying screw 13b2) form a circulation path in which the developer Gis conveyed in the longitudinal direction of the first conveying screw 13b1 and the rotation axis direction of the second conveying screw 13b2 in the developing device 13. In other words, when the developing device 13 rotates, the developer G stored in the developing device 13 flows in the direction indicated by the dashed arrow in FIG. 3. As described above, the circulation path of the developer G (the first conveyance passage B1 and the second conveyance passage B2) with respect to the developing roller 13a is not horizontally but vertically formed, so that the size of the developing device 13 can be reduced in the horizontal direction (the size of the developing device 13 can be extended in the vertical direction). In particular, in the tandem-color image forming apparatus 1 in which the plurality of developing devices 13 (image forming devices) are arranged in the horizontal direction, reducing the horizontal sizes of the plurality of developing devices 13 (image forming devices) can effectively reduce the entire size of the image forming apparatus 1 in the horizontal direction.

In the conveyance path including the second conveying screw 13b2, the toner concentration sensor 13x is disposed to detect the toner concentration of the developer G circulating in the developing device 13. Then, new toner T is supplied from the toner container 28 toward the developing device 13 via the supply port 13d (which is disposed outside the second communication portion 13g in the longitudinal direction) based on the information of the toner concentration detected by the toner concentration sensor 13x. With reference to FIG. 3, the supply port 13d (a toner supply inlet) is disposed above the upstream end of the second conveyance path B2 including the second conveying screw 13b2 and away from the developing region (outside the range of the developing roller 13a in the longitudinal direction). The new toner T discharged from the toner container 28 is appropriately supplied to the inside of the developing device 13 via the supply port 13d (supplied in the direction indicated by the white arrow in FIG. 3). Disposing the supply port 13d in the vicinity of the second communication portion 13g as described above enables the supplied toner to be sufficiently dispersed and mixed with the developer G falling by its own weight from the second communication portion 13g and supplied to the downstream side of the second conveyance path B2 over a relatively long time. In the present embodiment, the supply port 13d is disposed in the second conveyance path B2. However, the position of the supply port 13d is not limited to this, and for example, the supply port 13d may be disposed above the downstream side by extending the first conveyance path B1 in the longitudinal direction.

The developer G delivered from the second conveyance path B2 to the first conveyance path B1 is likely to stay in the vicinity of the first communication portion 13f, so that the surface level of the developer G is high at a position close to the first communication portion 13f and low at a position far from the first communication portion 13f in both the first conveyance path B1 and the second conveyance path B2, as illustrated in FIG. 4. The developer G falls by its own weight from the first conveyance path B1 toward the second conveyance path B2 in the vicinity of the second communication portion 13g. For this reason, as illustrated in FIG. 4, the developer G that has fallen by its own weight in the vicinity of the second communication portion 13g stays in the second conveyance path B2, and thus, the surface level of the developer G becomes slightly higher.

With reference to FIG. 2, the developing device 13 according to the present embodiment has a vent in the developing case 13j to communicate with the outside of the developing device 13 in the vicinity of the developing roller 13a. The filter 13k that collects the developer G to allow air to pass through is installed to cover a vent D.

The configuration and operation of the developing device 13 according to the present embodiment is described below. As described above with reference to FIGS. 2, 3, and 4, the developing device 13 includes a partition 13e. The partition 13e is disposed to separate the first conveyance path B1, in which the first conveying screw 13b1 is disposed, and the second conveyance path B2, in which the second conveying screw 13b2 is disposed, in a region excluding the first communication portion 13f formed on one end (on the right side in FIGS. 3 and 4) in the longitudinal direction and the second communication portion 13g formed on the other end (on the left side in FIGS. 3 and 4) in the longitudinal direction. The toner concentration sensor 13x that detects the toner concentration of the developer G in the developing device 13 is disposed at the bottom of the second conveyance passage B2. With reference to FIGS. 2 and 3, the partition 13e is substantially parallel to the bottom of the second conveying screw 13b2 (where the toner concentration sensor 13x is disposed) and extends in the substantially horizontal direction.

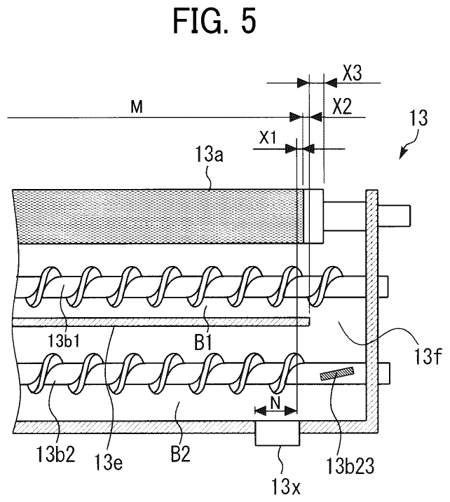

With reference to FIG. 5, in the developing device 13 according to the present embodiment, the toner concentration sensor 13x is installed such that a detection region Nin the longitudinal direction thereof is located at a position below the partition 13e at the bottom of the second conveyance passage B2 and closer (as close as possible) to the first communication portion 13f.

Specifically, the developing roller 13a (the sleeve 13a2) has a scooping region M including a plurality of grooves (for example, V grooves or DA grooves) on the surface of the developing roller 13a. The scooping region M is a region except for both ends (the first communication portion 13f and the second communication portion 13g) in the longitudinal direction. The scooping region M is a portion grooved to facilitate scooping (bearing) of the developer G on the developing roller 13a, and is substantially equal to or slightly larger than a developable range in the longitudinal direction. Accordingly, the portions (both ends) outside the range of the scooping region M on the developing roller 13a are portions that do not contribute to the development process. As illustrated in FIG. 5, one end (right end) of the scooping region M in the longitudinal direction is located outside (on the right side) by a distance X1 from one end of the detection region N of the toner concentration sensor 13x in the longitudinal direction. The detection region Nis a region in which the toner concentration is detectable, and is substantially synonymous with the range of a detection surface 13x1 (see FIG. 7). The one end (right end) of the partition 13e in the longitudinal direction is located outside (on the right side) by a distance X2 from the one end (right end) of the scooping region M in the longitudinal direction. The one end (right end) of the developing roller 13a in the longitudinal direction is located outside (on the right side) by a distance X3 from the one end (right end) of the partition 13e in the longitudinal direction.

As described above, in the present embodiment, the toner concentration sensor 13x (detection region N) disposed at the bottom of the second conveyance path B2 is disposed at a position below the partition 13e and as close as possible to the first communication portion 13f (which is the region where the developer Gis lifted). Such a configuration can increase the detection accuracy of the toner concentration sensor 13x, and further, even immediately after the start of driving of the developing device 13, the detection result of the toner concentration sensor 13x is likely to be stabilized. Specifically, it is preferable to install the toner concentration sensor 13x on the side (the right side in FIG. 5) close to the region where the supply amount of the developer G in the detection region Nis stable and the developer G has a sufficient bulk, in order to enhance the detection accuracy of the toner concentration by the toner concentration sensor 13x in the developing device 13. However, in the region (first communication portion 13f) where the developer G is lifted, the developer G receives pressure (pressure from the developer G) from multiple directions including the force lifting the developer G upward, and thus, if the toner concentration sensor 13x is disposed below the first communication portion 13f, the detection accuracy of the toner concentration sensor 13x is not stable. If the toner concentration sensor 13x is disposed below the first communication portion 13f, it takes time for the direction of the force that acts on the toner concentration sensor 13x to converge after the developing device 13 starts to be driven, depending on the position of the toner concentration sensor 13x. Thus, it takes time for the detection result of the toner concentration to stabilize. For this reason, the toner concentration sensor 13x is disposed in a region (left side in FIG. 5) having an inner surface of the partition 13e that separates the first conveyance path B1 on the upper side and the second conveyance path B2 on the lower side while the toner concentration sensor 13x is disposed close to the first communication portion 13f (the developer lifting region) so that unnecessary developer pressure can be minimized in the detection region N of the toner concentration sensor 13x (or so that the toner concentration sensor 13x does not receive the developer pressure from multiple directions). In the present embodiment, the position of the toner concentration sensor 13x is optimized in this way. Thus, the detection accuracy of the toner concentration sensor 13x is high, and the detection result of the toner concentration sensor 13x is likely to be stable even immediately after the driving of the developing device 13 is started. Accordingly, the toner concentration of the developer G stored in the developing device 13 is less likely to vary, and the density of the image to be printed is also likely to be stable.

In the present embodiment, the one end (right end) of the detection region N of the toner concentration sensor 13x in the longitudinal direction, the one end (right end) of the scooping region M in the longitudinal direction, the one end (right end) of the partition 13e in the longitudinal direction, and the one end (right end) of the developing roller 13a in the longitudinal direction are arranged in this order from the center in the longitudinal direction. Such a configuration can make the layout of the developing device 13 in the longitudinal direction compact while minimizing the influence on the scooping of the developer G to the developing roller 13a due to the disturbance of the developer G in the first communication portion 13f (the portion where the developer G is delivered).

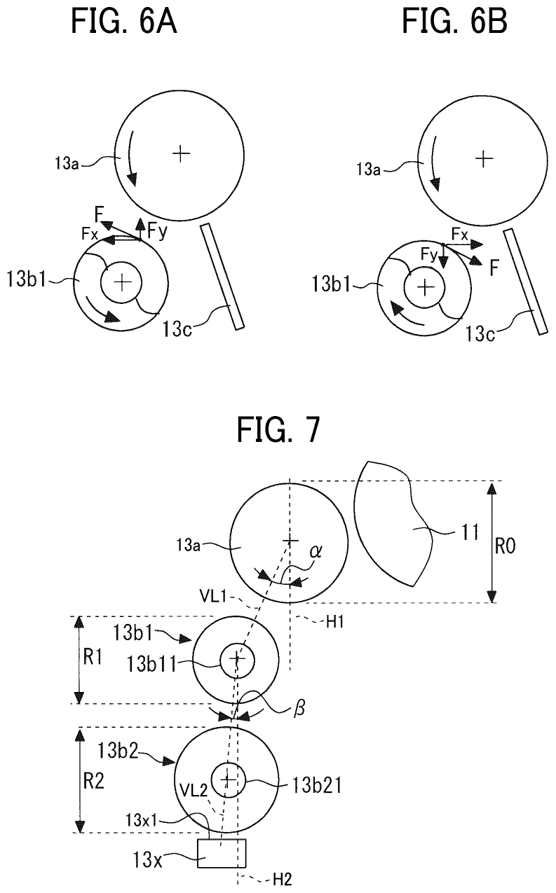

As described above, in the present embodiment, the developing roller 13a rotates in the direction opposite to the rotation direction of the photoconductor drum 11 (image bearer) (in the direction indicated by the arrow in FIG. 6A, i.e., in the counterclockwise direction). The first conveying screw 13b1 and the second conveying screw 13b2 rotate in the same direction (the direction indicated by the arrow in FIG. 6A, which is the counterclockwise direction) as the rotation direction of the developing roller 13a. With reference to FIG. 6A, a vector F (in a rotation direction in which the supply (transfer) of the developer G from the first conveying screw 13b1 to the developing roller 13a is directed in a direction slightly inclined) is decomposed into a vertical component Fy and a horizontal component Fx. When the first conveying screw 13b1 rotates in the counterclockwise direction, the vertical component Fy of the vector F is directed upward (toward the developing roller 13a). Accordingly, the supply performance (delivery performance) of the developer G from the first conveying screw 13b1 to the developing roller 13a is enhanced. On the other hand, with reference to FIG. 6B as a comparative example, when the rotation direction of the first conveying screw 13b1 is set to the direction indicated in FIG. 6B (clockwise direction), the above-described vertical component Fy is directed downward (in a direction away from the developing roller 13a). As a result, the supply performance (delivery performance) of the developer G from the first conveying screw 13b1 to the developing roller 13a is lowered as compared to the case of FIG. 6A.

In the present embodiment, when viewed in a cross section orthogonal to the rotation axis of the developing roller 13a (or the first conveying screw 13b1 and the second conveying screw 13b2) as illustrated in FIG. 7, a virtual line VL1 connecting the rotation center of the developing roller 13a and the rotation center of the first conveying screw 13b1 is inclined obliquely downward and away from the photoconductor drum 11 (image bearer) by an angle of 30±10 degrees with respect to a vertical line H1. A virtual line VL2 connecting the rotation center of the first conveying screw 13b1 and the rotation center of the second conveying screw 13b2 is inclined obliquely downward and away from the photoconductor drum 11 by an angle of 20 degrees or less with respect to a vertical line H2. The virtual line VL2 connecting the rotation center of the second conveying screw 13b2 and the center of the detection surface 13x1 of the toner concentration sensor 13x is inclined obliquely downward and away from the photoconductor drum 11 by an angle of 20 degrees or less with respect to the vertical line H2. In the present embodiment, the virtual line VL2 is a line in which a virtual line connecting the rotation center of the first conveying screw 13b1 and the rotation center of the second conveying screw 13b2 is substantially extended. Such a configuration further reliably enhances the supply performance (delivery performance) of the developer G from the first conveying screw 13b1 to the developing roller 13a as described above with reference to FIG. 6. Such a configuration smoothly enhances the supply performance (delivery performance) of the developer G from the second conveying screw 13b2 (second conveyance path B2) to the first conveying screw 13b1 (first conveyance path B1) at the first communication portion 13f. Such a configuration smoothly enhances the flow of the developer G in the vicinity of the toner concentration sensor 13x by the second conveying screw 13b2 (second conveying path B2) in conjunction with the above-described flow of the developer G, and thus enhances the accuracy of the toner concentration detection.

As illustrated in FIG. 7, in the present embodiment, the shaft 13b21 of the second conveying screw 13b2 and the shaft 13b11 of the first conveying screw 13b1 are located above the toner concentration sensor 13x when viewed in a cross section orthogonal to the rotation axis of the developing roller 13a. Such a configuration enhances the accuracy of the toner concentration detection of the toner concentration sensor 13x as compared with a case where the toner concentration sensor 13x (detection surface 13x1) is disposed at a lower portion away from the shaft 13b11 of the first conveying screw 13b1 and the shaft 13b21 of the second conveying screw 13b2.

With reference to FIG. 7, in the present embodiment, a roller diameter R0 of the developing roller 13a is larger than a screw diameter R2 of the second conveying screw 13b2, and the screw diameter R2 of the second conveying screw 13b2 is larger than a screw diameter R1 of the first conveying screw 13b1 (R0>R2>R1). Such a configuration balances the supply performance (delivery performance) of the developer G from the first conveying screw 13b1 to the developing roller 13a and the supply performance (delivery performance) of the developer G from the second conveying screw 13b2 (second conveyance path B2) to the first conveying screw 13b1 (first conveyance path B1) at the first communication portion 13f, and thus achieves the smooth flow of the developer G in the circulation path in the developing device 13.

As described above, the developing device 13 according to the present embodiment is a developing device that stores the developer G and develops a latent image formed on the surface of the photoconductor drum 11 (image bearer). The developing device 13 includes the developing roller 13a that faces the photoconductor drum 11 and bears the developer G. The developing device 13 includes the first conveying screw 13b1 disposed below the developing roller 13a to face the developing roller 13a. The first conveying screw 13b1 supplies the developer G to the developing roller 13a while conveying the developer G from one end in the longitudinal direction toward the other end in the longitudinal direction and collects the developer G separated from the developing roller 13a. The developing device 13 includes the second conveying screw 13b2 disposed below the first conveying screw 13b1 to be opposite the first conveying screw 13b1. The second conveying screw 13b2 conveys the developer G from the other end in the longitudinal direction toward the one end in the longitudinal direction and forms a circulation path of the developer G together with the first conveying screw 13b1. The developing device 13 includes the partition 13e. The partition 13e is disposed to separate the first conveyance path B1, in which the first conveying screw 13b1 is disposed, and the second conveyance path B2, in which the second conveying screw 13b2 is disposed, in a region excluding the first communication portion 13f formed on one end in the longitudinal direction and the second communication portion 13g formed on the other end in the longitudinal direction. The toner concentration sensor 13x that detects the toner concentration of the developer G is disposed. The toner concentration sensor 13x is disposed such that the detection region N in the longitudinal direction is located at a position below the partition 13e at the bottom of the second conveyance path B2 and close to the first communication portion 13f. As a result, the detection accuracy of the toner concentration sensor 13x is high, and the detection result of the toner concentration sensor 13x is likely to be stable even immediately after the driving of the developing device 13 is started.

In the present embodiment, the developing device 13 is one of the components of the process cartridge 10. The present disclosure is not limited to the present embodiment described above, and the developing device 13 alone may be detachably attached as a single unit to the body of the image forming apparatus 1. The term “process cartridge” used in the present disclosure is defined as a unit that includes an image bearer united with at least one of a charger to charge the image bearer, a developing device to develop a latent image on the image bearer, and a cleaning device to clean a surface of the image bearer, and that is detachably attached to a body of an image forming apparatus.

Note that embodiments of the present disclosure are not limited to the above-described embodiments and it is apparent that the above-described embodiments can be appropriately modified within the scope of the technical idea of the present embodiment in addition to what is suggested in the above-described embodiments. Further, features of components of the embodiments, such as the number, the position, and the shape are not limited the embodiments and thus may be preferably set.

In the specification of the present application, directions such as “upward” and “downward” are defined as directions in a posture in a normal use state of a developing device or an image forming apparatus.

Note that aspects of the present disclosure may be, for example, a combination of the first to fourteenth aspects as follows.

### First Aspect

A developing device (e.g., the developing device 13) that develops a latent image formed on a surface of an image bearer (e.g., the photoconductor drum 11) includes a developing roller (e.g., the developing roller 13a), a first conveying screw (e.g., the first conveying screw 13b1), a second conveying screw (e.g., the second conveying screw 13b2), a partition (e.g., the partition 13e), and a toner concentration sensor (e.g., the toner concentration sensor 13x). The developing roller faces the image bearer and bears developer (e.g., the developer G). The first conveying screw is disposed below the developing roller to face the developing roller, supplies the developer to the developing roller while conveying the developer from one end to the other end in a longitudinal direction, and collects the developer separated from the developing roller. The second conveying screw is disposed below and opposite the first conveying screw, conveys the developer from the other end to the one end in the longitudinal direction, and forms a circulation path for the developer together with the first conveying screw. The partition separates a first conveyance path (e.g., the first conveyance path B1) in which the first conveying screw is disposed and a second conveyance path (e.g., the second conveyance path B2) in which the second conveying screw is disposed, in a region excluding a first communication portion (e.g., the first communication portion 13f) formed on one end in the longitudinal direction and a second communication portion (e.g., the second communication portion 13g) formed on the other end in the longitudinal direction. The toner concentration sensor detects the toner concentration of the developer. The toner concentration sensor is disposed such that a detection region of the toner concentration sensor in the longitudinal direction is located below the partition at a bottom of the second conveyance path and at a position close to the first communication portion.

### Second Aspect

In the developing device (e.g., the developing device 13) according to the first aspect, a region excluding both ends of the developing roller (e.g., the developing roller 13a) in the longitudinal direction is a scooping region having a plurality of grooves formed on a surface of the developing roller. One end of the scooping region in the longitudinal direction is located outside one end of the detection region in the longitudinal direction. One end of the partition (e.g., the partition 13e) in the longitudinal direction is located outside the one end of the scooping region in the longitudinal direction. One end of the developing roller in the longitudinal direction is located outside the one end of the partition in the longitudinal direction.

### Third Aspect

In the developing device (e.g., the developing device 13) according to the first or second aspect, the second conveying screw (e.g., the second conveying screw 13b2) includes a shaft (e.g., the shaft 13b21) facing the first communication portion (e.g., the first communication portion 13f), a screw portion (e.g., the screw portion 13b22) wound around the shaft, and a paddle (e.g., the paddle portion 13b23) standing in a radial direction on the shaft.

### Fourth Aspect

In the developing device (e.g., the developing device 13) according to any one of the first to third aspects, the shaft (e.g., the shaft 13b21) of the second conveying screw (e.g., the second conveying screw 13b2) and a shaft (e.g., the shaft 13b11) of the first conveying screw (e.g., the first conveying screw 13b1) are located above the toner concentration sensor (e.g., the toner concentration sensor 13x) when viewed in a cross section orthogonal to a rotation axis of the developing roller (e.g., the developing roller 13a).

### Fifth Aspect

In the developing device (e.g., the developing device 13) according to any one of the first to fourth aspects, when viewed in a cross-section orthogonal to a rotation axis of the developing roller (e.g., the developing roller 13a), a virtual line (e.g., the virtual line VL1) connecting the rotation center of the developing roller and the rotation center of the first conveying screw (e.g., the first conveying screw 13b1) is inclined obliquely downward away from the image bearer (e.g., the photoconductor drum 11) by an angle of 30±10 degrees with respect to a vertical line (e.g., the vertical line H1). A virtual line (e.g., the virtual line VL2) connecting the rotation center of the first conveying screw and the rotation center of the second conveying screw (e.g., the second conveying screw 13b2) is inclined obliquely downward away from the image bearer by an angle of 20 degrees or less with respect to a vertical line (e.g., the vertical line H2). The virtual line (e.g., the virtual line VL2) connecting the rotation center of the second conveying screw and the center of a detection surface of the toner concentration sensor (e.g., the toner concentration sensor 13x) is inclined obliquely downward away from the image bearer by an angle of 20 degrees or less with respect to a vertical line (e.g., the vertical line H2).

### Sixth Aspect

In the developing device (e.g., the developing device 13) according to any one of the first to fifth aspects, a roller diameter of the developing roller (e.g., the developing roller 13a) is greater than a screw diameter of the second conveying screw (e.g., the second conveying screw 13b2). The screw diameter of the second conveying screw is greater than a screw diameter of the first conveying screw (e.g., the first conveying screw 13b1).

### Seventh Aspect

In the developing device (e.g., the developing device 13) according to any one of the first to sixth aspects, the developing roller (e.g., the developing roller 13a) rotates in a direction opposite to a rotation direction of the image bearer (e.g., the photoconductor drum 11). The first conveying screw (e.g., the first conveying screw 13b1) and the second conveying screw (e.g., the second conveying screw 13b2) rotate in the same direction as the direction in which the developing roller rotates.

### Eighth Aspect

In the developing device (e.g., the developing device 13) according to any one of the first to seventh aspects, the partition (e.g., the partition 13e) extends substantially parallel to the bottom of the second conveyance path (e.g., the second conveyance path B2) and in a substantially horizontal direction.

### Ninth Aspect

A process cartridge (e.g., the process cartridge 10) is removably installed to a body of an image forming apparatus (e.g., the image forming apparatus 1). The process cartridge includes the developing device (e.g., the developing device 13) according to any one of the first to eighth aspects and the image bearer (e.g., the photoconductor drum 11) united with each other.

### Tenth Aspect

An image forming apparatus (e.g., the image forming apparatus 1) includes the developing device (e.g., the developing device 13) according to any one of the first to eighth aspects and the image bearer (e.g., the photoconductor drum 11).

### Eleventh Aspect

A developing device (e.g., the developing device 13) that develops a latent image formed on a surface of an image bearer (e.g., the photoconductor drum 11) includes a developing roller (e.g., the developing roller 13a), a first conveying screw (e.g., the first conveying screw 13b1), a second conveying screw (e.g., the second conveying screw 13b2), and a toner concentration sensor (e.g., the toner concentration sensor 13x). The developing roller faces the image bearer and bears developer (e.g., the developer G). The first conveying screw is disposed below the developing roller to face the developing roller, supplies the developer to the developing roller while conveying the developer from one end to the other end in a longitudinal direction, and collects the developer separated from the developing roller. The second conveying screw is disposed below and opposite the first conveying screw, conveys the developer from the other end to the one end in the longitudinal direction, and forms a circulation path for the developer together with the first conveying screw. The toner concentration sensor detects the toner concentration of the developer. A diameter of the developing roller is larger than a diameter of the second conveying screw. The diameter of the second conveying screw is larger than a diameter of the first conveying screw.

### Twelfth Aspect

In the developing device (e.g., the developing device 13) according to the eleventh aspect, a center of a shaft (e.g., the shaft 13b21) of the second conveying screw (e.g., the second conveying screw 13b2) and a center of a shaft (e.g., the shaft 13b11) of the first conveying screw (e.g., the first conveying screw 13b1) are located above the toner concentration sensor (e.g., the toner concentration sensor 13x) and within a width of the toner concentration sensor.

### Thirteenth Aspect

A process cartridge (e.g., the process cartridge 10) removably installed to a body of an image forming apparatus (e.g., the image forming apparatus 1) includes the developing device (e.g., the developing device 13) according to the eleventh aspect and the image bearer (e.g., the photoconductor drum 11) united with each other.

### Fourteenth Aspect

An image forming apparatus (e.g., the image forming apparatus 1) includes the developing device (e.g., the developing device 13) according to the eleventh aspect and the image bearer (e.g., the photoconductor drum 11).

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A developing device that develops a latent image formed on a surface of an image bearer, the developing device comprising:
a housing to store developer;
a developing roller to:
face the image bearer; and
bear the developer;
a first conveying screw disposed below the developing roller and facing the developing roller to:
supply the developer to the developing roller while conveying the developer from one end to another end of the housing in a longitudinal direction of the housing; and
collect the developer separated from the developing roller;
a second conveying screw disposed below and opposite the first conveying screw to:
convey the developer from said another end to the one end of the housing in the longitudinal direction; and
form a circulation path for the developer together with the first conveying screw;
a partition separating a first conveyance path in which the first conveying screw is disposed and a second conveyance path in which the second conveying screw is disposed, in a region excluding a first communication portion formed on the one end of the housing in the longitudinal direction and a second communication portion formed on said another end of the housing in the longitudinal direction; and
a toner concentration sensor to detect a toner concentration of the developer,
wherein a detection region of the toner concentration sensor in the longitudinal direction is located below the partition at a bottom of the second conveyance path and at a position close to the first communication portion.

2. The developing device according to claim 1,
wherein a region excluding both ends of the developing roller in the longitudinal direction is a scooping region having a plurality of grooves formed on a surface of the developing roller,
wherein one end of the scooping region in the longitudinal direction is located outside one end of the detection region of the toner concentration sensor in the longitudinal direction,
wherein one end of the partition in the longitudinal direction is located outside the one end of the scooping region in the longitudinal direction, and
wherein one end of the developing roller in the longitudinal direction is located outside the one end of the partition in the longitudinal direction.

3. The developing device according to claim 1,
wherein the second conveying screw includes a shaft facing the first communication portion, a screw portion wound around the shaft, and a paddle standing in a radial direction on the shaft.

4. The developing device according to claim 1,
wherein a shaft of the second conveying screw and a shaft of the first conveying screw are located above the toner concentration sensor when viewed in a cross section orthogonal to a rotation axis of the developing roller.

5. The developing device according to claim 1,
wherein a virtual line connecting a rotation center of the developing roller and a rotation center of the first conveying screw is inclined obliquely downward away from the image bearer by an angle of 30±10 degrees with respect to a first vertical line passing the rotation center of the developing roller when viewed in a cross-section orthogonal to a rotation axis of the developing roller,
wherein a virtual line connecting the rotation center of the first conveying screw and a rotation center of the second conveying screw is inclined obliquely downward away from the image bearer by an angle of 20 degrees or less with respect to a second vertical line passing the rotation center of the first conveying screw when viewed in the cross-section orthogonal to the rotation axis of the developing roller, and
wherein a virtual line connecting the rotation center of the second conveying screw and a center of a detection surface of the toner concentration sensor is inclined obliquely downward away from the image bearer by an angle of 20 degrees or less with respect to the second vertical line when viewed in a cross-section orthogonal to the rotation axis of the developing roller.

6. The developing device according to claim 1,
wherein a roller diameter of the developing roller is greater than a screw diameter of the second conveying screw, and
wherein the screw diameter of the second conveying screw is greater than a screw diameter of the first conveying screw.

7. The developing device according to claim 1,
wherein the developing roller rotates in a direction opposite to a rotation direction of the image bearer, and
wherein the first conveying screw and the second conveying screw rotate in the same direction as the direction in which the developing roller rotates.

8. The developing device according to claim 1,
wherein the partition extends substantially parallel to the bottom of the second conveyance path and in a substantially horizontal direction.

9. A process cartridge attachable to and detachable from a body of an image forming apparatus, the process cartridge comprising:
the developing device according to claim 1; and
the image bearer united with the developing device.

10. An image forming apparatus comprising:
the developing device according to claim 1; and
the image bearer.

11. A developing device that develops a latent image formed on a surface of an image bearer, the developing device comprising:
a housing to store developer;
a developing roller to:
face the image bearer; and
bear the developer;
a first conveying screw disposed below the developing roller and facing the developing roller to:
supply the developer to the developing roller while conveying the developer from one end to another end of the housing in a longitudinal direction of the housing; and
collect the developer separated from the developing roller;
a second conveying screw disposed below and opposite the first conveying screw to:
convey the developer from said another end to the one end of the housing in the longitudinal direction; and
form a circulation path for the developer together with the first conveying screw; and
a toner concentration sensor to detect a toner concentration of the developer,
wherein a roller diameter of the developing roller is greater than a screw diameter of the second conveying screw, and
wherein the screw diameter of the second conveying screw is greater than a screw diameter of the first conveying screw.

12. The developing device according to claim 11,
wherein a center of a shaft of the second conveying screw and a center of a shaft of the first conveying screw are located above the toner concentration sensor and within a width of the toner concentration sensor.

13. A process cartridge attachable to and detachable from a body of an image forming apparatus, the process cartridge comprising:
the developing device according to claim 11; and
the image bearer united with the developing device.

14. An image forming apparatus comprising:
the developing device according to claim 11; and
the image bearer.
